(19) United States
(12) Patent Application Publication
(10) Pub. No.: US 2007/0120708 A1
(43) Pub. Date: May 31, 2007

(54) METHODS AND SYSTEMS FOR MONITORING AIRCRAFT APPROACH BETWEEN APPROACH GATES

(75) Inventors: Yasuo Ishihara, Kirkland, WA (US); Steve C. Johnson, Issaquah, WA (US); Kevin J. Conner, Kent, WA (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: Honeywell International Inc., Morristown, NJ (US)

(21) Appl. No.: 11/470,188

(22) Filed: Sep. 5, 2006

Related U.S. Application Data
(60) Provisional application No. 60/715,809, filed on Sep. 9, 2005.

(51) Int. Cl. G08B 23/00; G08B 21/00

(52) U.S. Cl. 340/963; 340/960

(57) ABSTRACT

Using signals available into an Enhanced Ground Proximity Warning System (EGPWS), approach monitor systems and methods compare approach speed, approach angle and amount of tailwind/crosswind to the pre-selected envelopes. When the aircraft approach speed, approach angle, or tailwind/crosswind is greater than the pre-defined envelope, the approach monitor system generates an aural/visual advisory indicating the violation. The envelope is set as a function of “height above runway elevation”.

### PRIORITY CLAIM

This application claims the benefit of U.S. Provisional Application Ser. No. 60/715,809 filed Sep. 9, 2005, the contents of which are hereby incorporated by reference.

### BACKGROUND OF THE INVENTION

Many airline operators have procedures for flight crews to adhere to when flying through “approach gates”. As part of these procedures, the non-flying pilot is instructed to monitor various flight parameters at the “approach gates.” These parameters include maximum operating speed, maximum altitude, maximum tailwind/crosswind, state of landing gear and state of landing flaps at during approach. 1,000 feet and 500 feet are typical “approach gates” altitude values. If the non-flying pilot observes that any of these parameters are outside of acceptable limits, they are instructed to inform the flying pilot. When any deviation is too great, the pilots are instructed to perform a go around or missed approach according to the company procedure.

In many large airframed aircraft, when the pilot performing the approach to landing is the most experienced of the two pilots in the cockpit, the co-pilot in the monitoring position is someone of lower seniority. This can be problematic at times. If the first pilot is not flying the aircraft according to the approach gate procedures, the junior co-pilot may be reluctant to advise the more senior pilot of his poor flying.

Regardless of who is in the monitoring position, the monitoring is still being performed by a human who may be distracted and thus not effectively monitor the aircraft conditions.

Therefore, there exists a need to assist the flight crew in making determinations of the flight information in order to better adhere to company policies.

### SUMMARY OF THE INVENTION

Using signals available into an Enhanced Ground Proximity Warning System (EGPWS), approach monitor systems and methods compare approach speed, approach angle and amount of tailwind/crosswind to the pre-selected envelopes. When the aircraft approach speed, approach angle, or tailwind/crosswind is greater than the pre-defined envelope, the approach monitor system generates an aural/visual advisory indicating the violation. The envelope is set as a function of “height above runway elevation” or radio altitude.

In other aspects of the present invention, position of landing gear and flaps are checked if they are in a landing mode configuration. An advisory is produced if either are not in the landing mode configuration at a certain distance and altitude from the runway.

### BRIEF DESCRIPTION OF THE DRAWINGS

Preferred and alternative embodiments of the present invention are described in detail below with reference to the following drawings:

FIG. 1 illustrates a schematic block diagram of an exemplary system formed in accordance with an embodiment of the present invention;

FIG. 2 illustrates an example method performed by the system shown in FIG. 1 in accordance with an embodiment of the present invention; and

FIGS. 3-5 illustrate graphs of acceptable variables as used in an analysis step of the method shown in FIG. 2.

### DETAILED DESCRIPTION OF THE PREFERRED EMBODIMENT

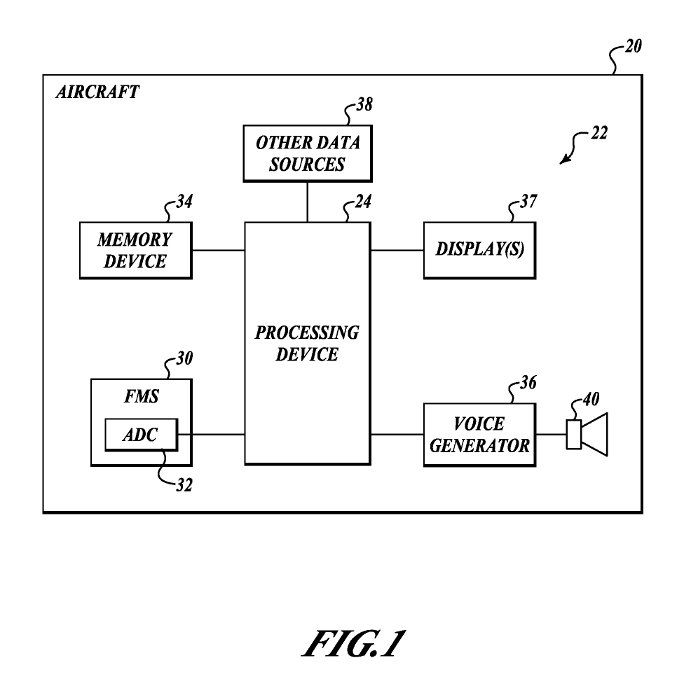

As shown in FIG. 1, an aircraft 20 includes a system 22 for providing information assistance to pilots with regard to aircraft operation between approach gates when approaching to land. The system 22 includes a processing device 24 that is in data communication with a memory device 34 and flight and aircraft configuration sensors either directly (other data sources 38 such as by using discrete signals) or via a Flight Management System (FMS) 30 which in one embodiment includes an Air Data Computer (ADC) 32. Also, the processing device 24 is in data communication with one or more displays 37 and a voice generator 36 that is connected to one or more speakers 40.

If the processing device 24 determines that aircraft parameters that are received from the FMS 30 or directly from other data sources 38 indicate that the aircraft 20 is not being flown in accordance with company policies or procedures (e.g., standard operating procedures) as they pertain to stability of the aircraft between predefined approach gates, then the processing device 24 produces advisories that are outputted via either one of the displays 37 or the speakers 40 via the voice generator 36.

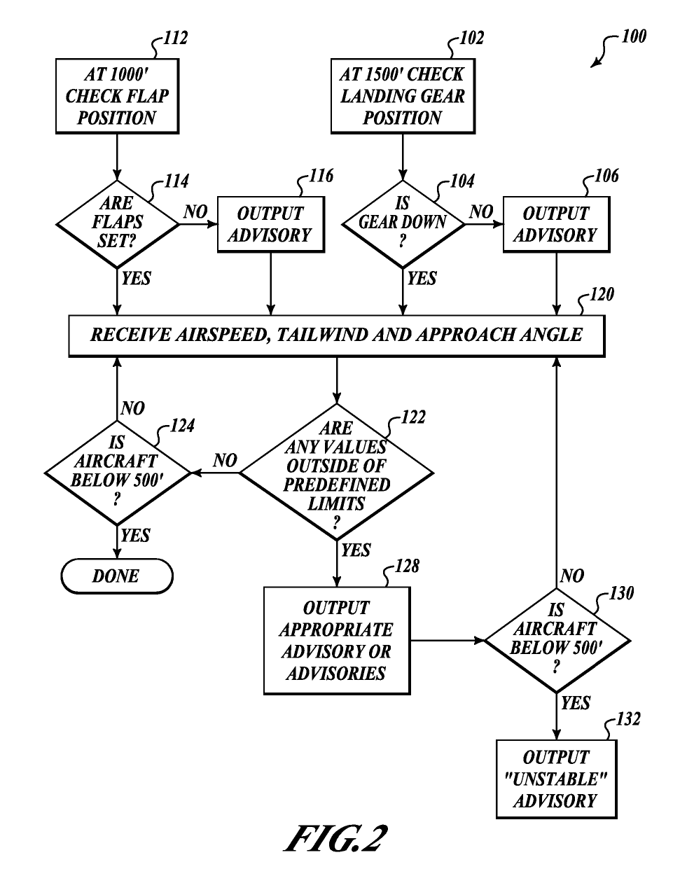

FIG. 2 illustrates an example process 100 performed by the processing device 24 shown in FIG. 1. First, at a block 102, the position of the landing gear is checked at approximately 1,500 feet altitude above the intended runway. Other altitudes may be used for the landing gear check. At decision block 104, the processor 24 determines if the gear is down. If the gear is determined not to be down at the decision block 104, then at a block 106, an advisory is output to either one of the speakers 40 via the generator 36 or the displays 37 to advise the flight crew that the gear is not down. At a block 114, the processing device 24 checks to see the position of the flaps at approximately 1,000 feet above the intended runway. Other altitudes may be used for the flap position check. At a decision block 116, the processing device 24 determines if the flaps are set in the landing configuration. If the flaps are not set in the landing configuration, then at a block 118, the processing device 24 outputs an advisory to either the displays 37 or the speakers 40 alerting the flight crew that the flaps are not currently in the landing configuration.

The intended runway is the runway that was selected by the flight crew or automatically selected by a runway picker algorithm performed by a processor-based device, such as the EGPWS or the device 24. An example runway picker algorithm is described in U.S. Pat. No. 6,304,800, the contents of which are hereby incorporated by reference. Altitude information of the intended runway is retrieved from the memory device 34 or some source (other aircraft or ground via a data link) external to the aircraft 20.

After blocks 106 and 116, if the gear is determined to be down (decision block 102) and if the flaps are determined to be set in the landing configuration (decision block 116), the process 100 continues on to block 120. At block 120, the processing device 24 receives air speed, tailwind, and approach angle information. At decision block 122, the processing device 24 determines if any of these received values are outside of predefined limits. If none of these values are outside the predefined limits, the process 100 continues to decision block 124 that checks to see if the aircraft 20 is below a second gate of predefined approach gates (e.g., 500 feet above the intended runway). If the aircraft is below the second gate, the process 100 is complete. If, however, the aircraft 20 is not below the second gate, in other words, the aircraft 20 is still within the altitude limits of the approach gates, then the process 100 returns to block 120. If at the decision block 122, anyone of the received values is outside of the predefined limits, then at a block 128, an appropriate advisory(ies) is outputted by the processing device 24 to one of the displays 37 or speakers 40.

Examples of outputted advisories include “too fast” if the air speed is outside of limits, “too high” if the approach angle is greater than the predefined limit, and “tailwind” if the tailwind exceeds a predefined limit. Other types of voice advisories may be used depending upon aircraft operator preference. Also, various types of visual advisories may be presented on the display 38 or may be the activation of a dedicated advisory light. Next, at a decision block 130, if the aircraft is determined not to be below 500 feet, the process 100 returns to the block 120. If the aircraft is below 500 feet above the runway and at least one of the values remains outside of the predefined limits, the processing device 24 outputs an unstable advisory to the displays 37 or the speakers 40.

The sampling and advisory output frequencies may be based on aircraft operator preference, but could be any value that presents the advisories to the flight crew in an effective manner.

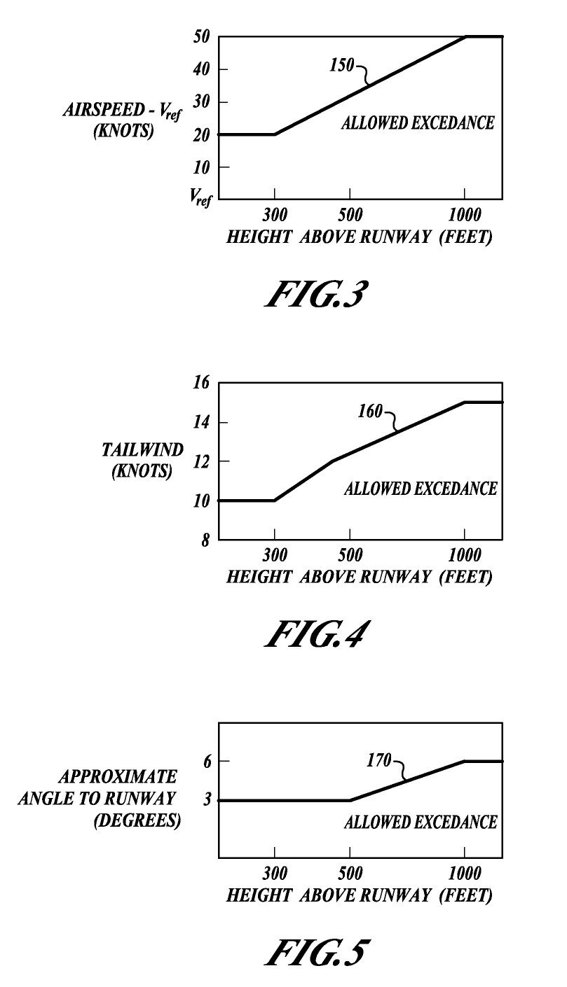

FIGS. 3-5 illustrate example predefined limits as used in the decision block 122 of FIG. 2. As shown in FIG. 3, a line 150 defines the allowed airspeed difference between a reference velocity (Vref) based on how high the aircraft 20 is above the intended runway. As shown in FIG. 4, a line 160 defines acceptable tailwind values based on how high the aircraft 20 is above the intended runway. As shown in FIG. 5, a line 170 defines acceptable approach angles based on how high the aircraft 20 is above the intended runway. The lines 150, 160, 170 may be of any geometry (curve, slope) depending upon desired results for the initiation of the associated advisories. Also, the lines 150, 160, 170 may have different limits on the x or y axis.

In another embodiment, wind direction and magnitude are received and a crosswind value is determined and compared to predefined limits in a similar manner as that shown and described for tailwind in FIG. 2.

While the preferred embodiment of the invention has been illustrated and described, as noted above, many changes can be made without departing from the spirit and scope of the invention. For example, the processing device 24 or functions performed by the processing device 24 may be included as part of existing devices, such as the FMS 30 or an Enhanced Ground Proximity Warning System (EGPWS) (not shown), or may be a separate unit. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for advising of flying condition when an aircraft flies through approach gates, the method comprising:
a) automatically receiving one or more flight parameters at a first gate of a pair of predefined approach gates;
b) automatically determining if any of the one or more flight parameters are not in compliance with a corresponding predefined limit; and
c) automatically outputting an associated advisory if it was determined that one or more of the flight parameters was not in compliance with the corresponding predefined limit.

2. The method of claim 1, further comprising automatically repeating a)-c) at least one or more times before the aircraft reaches a second gate of the approach gates.

3. The method of claim 2, further comprising automatically outputting an unstable advisory if it was determined that one or more of the flight parameters is not in compliance with the corresponding predefined limit after the aircraft reaches a second gate of the approach gates.

4. The method of claim 3, wherein outputting at least one of the associated advisory or the unstable advisory comprises generating a speech signal based on the advisory and outputting the speech signal to one or more speakers.

5. The method of claim 3, wherein outputting at least one of the associated advisory or the unstable advisory comprises generating a visual presentation based on the type of advisory and outputting the visual presentation to one or more displays.

6. The method of claim 3, wherein the first gate is approximately 1,000 feet and the second approach gate is approximately 500 feet above at least one of an intended runway or a radio altimeter value.

7. The method of claim 1, wherein the one or more flight parameters include at least one of aircraft air speed, tailwind, crosswind, or aircraft approach angle.

8. The method of claim 1, further comprising checking position of landing gear and advising if the landing gear is not in a down position prior to approaching the first gate.

9. The method of claim 8, further comprising checking the position of the flaps and automatically advising if the flaps are not in a landing mode configuration at approximately the first gate.

10. A system on an aircraft for advising of flying condition when the aircraft flies through approach gates, the system comprising:
one or more components for producing one or more flight parameters at a first gate of a pair of predefined approach gates; and
a processing device in data communication with the one or more components for automatically receiving the one or more flight parameters, automatically determining if any of the one or more flight parameters are not in compliance with a corresponding predefined limit, and automatically outputting an associated advisory if it was determined that one or more of the flight parameters was not in compliance with the corresponding predefined limit.

11. The system of claim 10, wherein the processing device automatically repeats at least one or more times before the aircraft reaches a second gate of the approach gates.

12. The system of claim 11, wherein the processing device automatically outputs an unstable advisory if it was determined that one or more of the flight parameters is not in compliance with the corresponding predefined limit after the aircraft reaches a second gate of the approach gates.

13. The system of claim 12, further comprising one or more speakers in signal communication with the processing device, wherein the processing device generates a speech signal based on the advisory and outputs the speech signal to the one or more speakers.

14. The system of claim 12, further comprising one or more displays in signal communication with the processing device, wherein the processing device generates a visual presentation based on the type of advisory and outputs the visual presentation to one or more displays.

15. The system of claim 12, wherein the first gate is approximately 1,000 feet and the second approach gate is approximately 500 feet above at least one of an intended runway or a radio altimeter value.

16. The system of claim 10, wherein the one or more flight parameters include at least one of aircraft air speed, tailwind, crosswind, or aircraft approach angle.

17. The system of claim 10, wherein the processing device checks position of landing gear and produces an advisory if the landing gear is not in a down position prior to approaching the first gate.

18. The system of claim 17, wherein the processing device checks the position of the flaps and produces an advisory if the flaps are not in a landing mode configuration at approximately the first gate.
